(19) United States
(12) Patent Application Publication
(10) Pub. No.: US 2015/0067460 A1
(43) Pub. Date: Mar. 5, 2015

(54) ANNOTATION PROCESSING METHOD, AND NON-TRANSITORY COMPUTER-READABLE MEDIUM

(71) Applicant: Perry H. Beaumont, Ridgefield, CT (US)

(72) Inventor: Perry H. Beaumont, Ridgefield, CT (US)

(21) Appl. No.: 14/014,489

(22) Filed: Aug. 30, 2013

(51) Int. Cl. G06F 17/30; G06F 17/22

(52) U.S. Cl. CPC G06F 17/30525; G06F 17/2235
USPC 715/205

(57) ABSTRACT

The present disclosure relates to a method to provide convenience and efficacy for annotation functionalities within electronic documents. Functionality includes, processed singly and/or in batch mode, the ability to create summaries of annotations within a preferred template, to follow hyperlinks within a document and thereby process any annotations contained within cross-referenced materials, and to embed multi-media content at particular document locations of interest to the user.

### BACKGROUND OF THE INVENTION

The present disclosure relates to a system and method to provide convenience and efficacy for annotation functionalities within electronic documents.

The existence of electronic documents permits written reports to be shared quickly via Email and other venues, and are increasingly used in preference to paper documentation. Electronic documents are collections or aggregations of electronic data, such as files or collections of files, which typically can be displayed with an appearance that resembles that of a paper document. Electronic documents can also be annotated in a variety of ways inclusive of, though not limited to, highlighting, underlying, abstracting text into summaries, embedding links or attachments of cross-referencing resources inclusive of websites, multimedia, and real-time data matching. A desirable feature of such annotations is that they can help to focus a reader's attention to particular areas of importance within an electronic document, and this can be especially useful when an electronic document is of great length. A shortcoming of such annotations, however, is that they require an exhaustive manual review of the full document inclusive of any hyperlinks and embedded multi-media to ensure that every annotation is appropriately considered. For documents running hundreds of pages in length, such a process of sourcing all annotations inclusive of following all hyperlinks and reviewing each multi-media embedded within the documents can be time consuming, and additionally poses the risk that key elements might be missed.

Another challenge for many document users relates to the length of time that a document is relevant. Some electronic documents are intended to have a short shelf-life, perhaps to communicate a change in company personnel or announce an upcoming meeting. Other electronic documentation, however, are complex in nature and are intended to serve as important references over a significant period of time. For example, a bond or loan document may be intended to be relevant for the life of the bond or loan, and this may be for a period of ten years or more. Further, there may be features of the bond or loan, such as covenants, that specify rights and obligations if certain events are triggered over the life of the bond or loan. An electronic document itself is static in nature, while the terms and conditions contained within the document are subject to day-to-day events.

The present disclosure addresses the incompleteness of existing document solutions by introducing features to facilitate convenience and efficacy. Regarding existing art, an example of the beneficial functionality of extraction functionality, U.S. Pat. No. 7,870,477 to Perelman et al., U.S. Pat. No. 8,380,650 to Kawai et al., U.S. Pat. No. 7,787,712 to Takahashi, et al., and U.S. Pat. No. 7,366,715 to Liu et al., incorporated by reference herein for all purposes, provides for the extraction of data from portable document files. There have also been inventions related to the matching of keywords in the context of electronic documents, as with U.S. Pat. No. 8,280,872 to Jha et. al.

### BRIEF DESCRIPTION OF THE DRAWINGS

FIG. 1 is a flow chart for describing the sequence of an annotation function call process in accordance with a preferred embodiment.

FIG. 2A, FIG. 2B, FIG. 2C, FIG. 2D, and FIG. 2E present screen shots related to an annotation function call to annotate, define, and record all manner of telephone and facsimile numbers, and having a separate summary file of recorded numbers be created and embedded within the annotated document version.

FIG. 3A, FIG. 3B, and FIG. 3C are screen shots illustrating a preferred embodiment of an annotated function call with a page extraction functionality, with extracted pages saved into a single electronic document, and with the ability for the user to define the preferred layout and format of the final product.

FIG. 4. is a flowchart presenting the sequence of an annotation function call capable of extracting a user-defined annotation from an electronic document inclusive of its hyperlinks and embedded resources.

FIG. 5 illustrates the embedding of one or more media files of varying types into user-designated locations of an electronic document, and with a registry of media types and respective page locations also available within a drop down menu embedded within the same electronic document.

FIG. 6 illustrates a method to sequence incorporating an annotation function call within the annotation process of an electronic document in the instance of a java script routine.

FIG. 7 illustrates one embodiment of a method for programming an electronic document annotation function call with batch processing capabilities.

### DETAILED DESCRIPTION

According to one or more embodiments, annotation refers to any and all types of document enhancements, inclusive of, though not limited to, highlighting, underlying, abstracting text into summaries, embedding links or attachments of cross-referencing resources inclusive of websites, multimedia, and real-time data matching.

According to some embodiments, automated annotation processes are integrated into electronic document software platforms, annotations can be processed for one document at a time or in a batch process, annotations can be processed individually or in combination with other annotations, and/or multiple annotations can be processed either sequentially or simultaneously. Summary files describing annotation results may be additionally available as automatically generated attachments (e.g., inserted within final annotation markups), and/or as separate electronic documents.

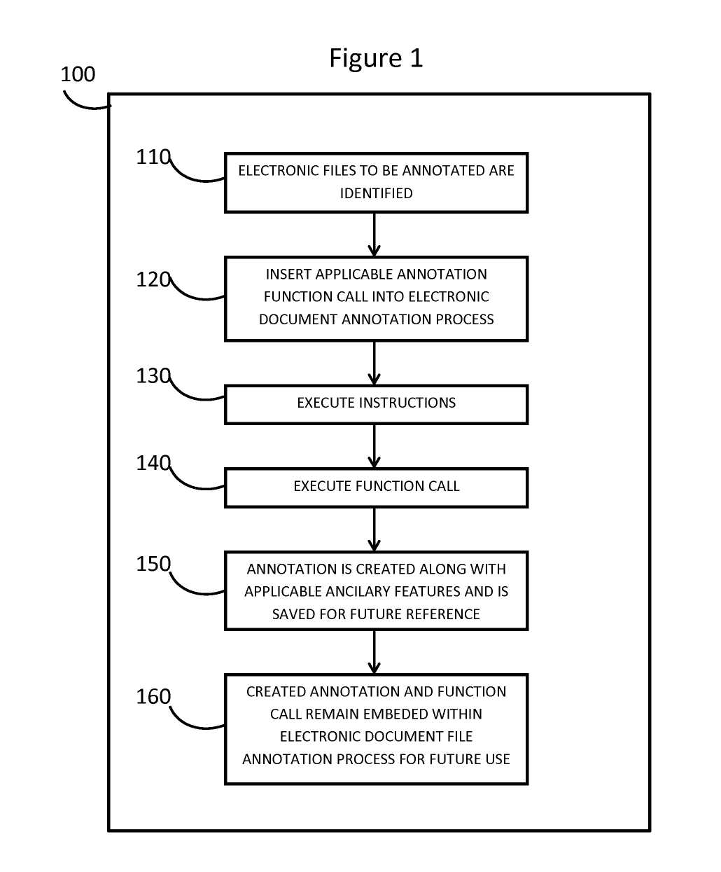

FIG. 1 illustrates a method 100 to sequence a scripted annotation for an electronic document that can be implemented within an electronic document process according to one embodiment. The method begins with the user identifying the electronic documents to be annotated (step 110).

A user then inserts the applicable annotation function call into an electronic document's annotation process (step 120), and this can be achieved with a manual or automated process. For example, a user may elect to manually place the particular annotation script (as with a java script) into a java script folder where other java script applications reside for a portable document file's annotation processes. A user might also use an automated process to have a particular java script placed in its appropriate location, as with selecting a tab, button, or option from a drop down menu or other user interface that identifies annotation types available for the document or application of interest. It is also possible that a particular annotation function call is automatically presented as an option to a user when a document is opened after the first time that the annotation function call is inserted into an electronic document's annotation process. For situations where multiple annotation java scripts are inserted into a given annotation process, the user can be prompted to choose a particular annotation to be applied as with a drop down menu or any other interactive user interface.

Each annotation type can have its own descriptive profile that dictates its appearance within an electronic document and how it is defined to a user, and this is detailed further below along with how profiles can be readily accessed by users.

When instructions for an annotation function call are executed (step 130), the user may be prompted to confirm intent to proceed with the annotation function call's installation. After the annotation function call instructions are executed and the annotation function call itself is executed (step 140), the annotation relating to the particular annotation function call will be performed along with any ancillary features of the annotation (step 150). For example, the particular annotation function call may not only generate the particular annotation requested for the electronic document, but it may additionally generate a summary report or log of the annotation process. The summary report or log can also be generated as a special attachment within the annotated electronic document itself. The execution of the annotation function call can also involve the user electing to perform the particular annotation on a single electronic document or on multiple documents. If the latter is desirable, a batch process can be used for an unlimited number of electronic documents to be filed at one time.

When the annotation process is complete and the annotated electronic document is saved, the annotation results remain embedded with the electronic document, and the annotation function call remains embedded within the PDF for future use unless manually removed or unless a user does not have a necessary software platform to view the embedded annotation function call (step 160).

A preferred embodiment of an automated solution permitting a variety of annotations to be readily identified and separately reported would appreciably enhance the efficacy, reliability, convenience, and completeness of any annotation process. For example, rather than have a reader manually pour over one-hundred pages of an electronic document to identify two pages worth of cumulative annotated text, hyperlinks, and multi-media, in one preferred embodiment the reader could instead click a button that embodies an automated solution whereby all relevant annotations are collated and exported into a user defined template. With this approach, a reader is saved from a painstaking manual review, and is instead provided with an abbreviated abstract self-contained within a preferred reporting template. Additionally, the automated solution is structured to distinguish among various types of annotations; for example, text that is underlined in green could be tagged as appropriate to report in one section of a reporting template such as “Executive Summary”, while text that is underlined in blue could be tagged as appropriate for reporting in another section of a template such as “Supporting information”.

In one preferred embodiment, the annotation function call is written in java script, and is embedded within the functionality of Adobe Acrobat in accordance with permissible terms and conditions. In addition to the annotation capabilities of the function call, the function call is additionally capable of generating a summary that profiles executed annotations as an attachment embedded within the extraction template or as a separate electronic document.

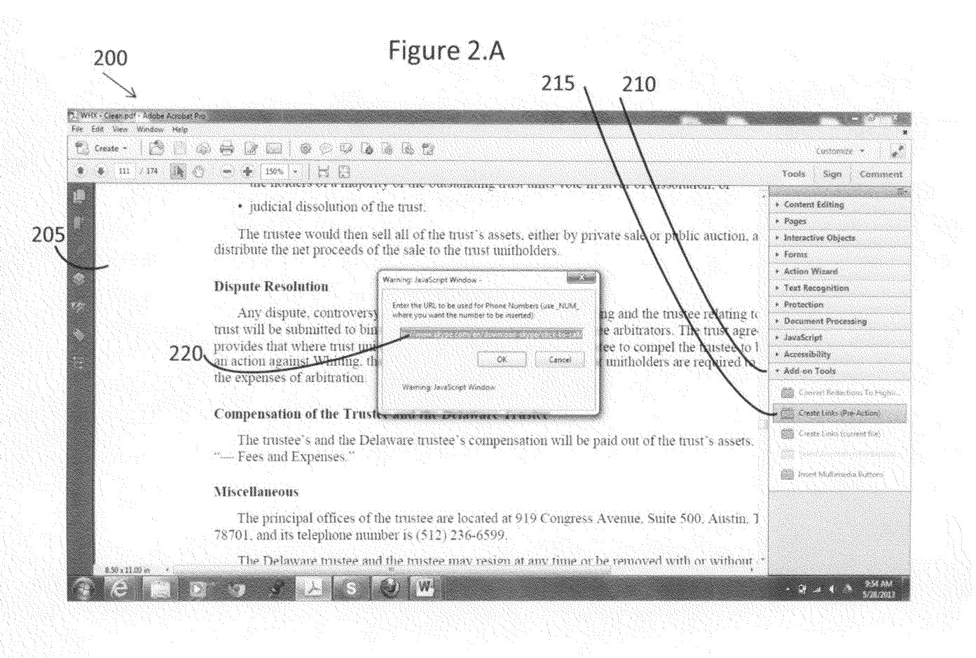

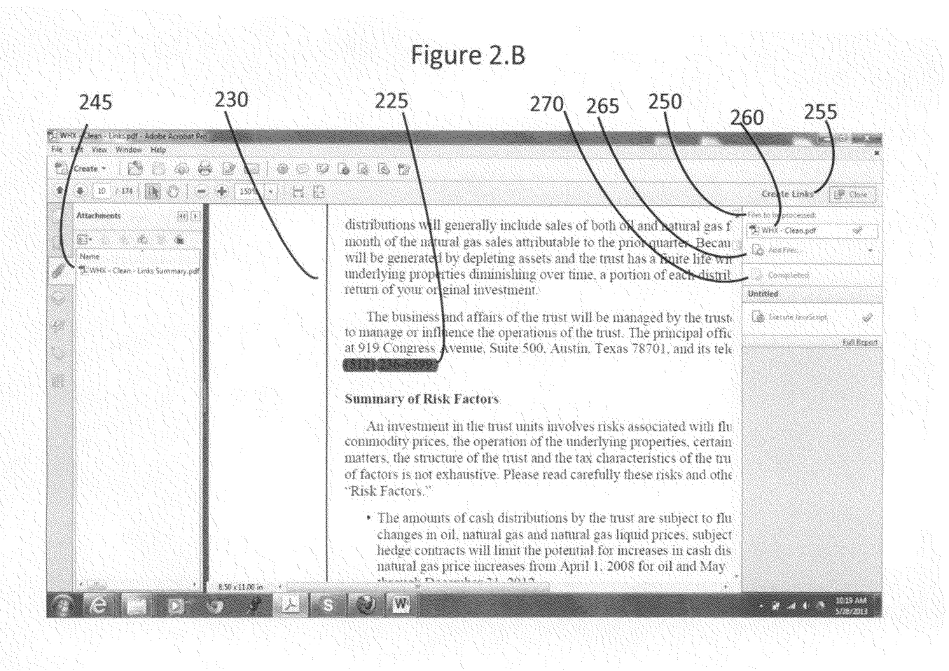

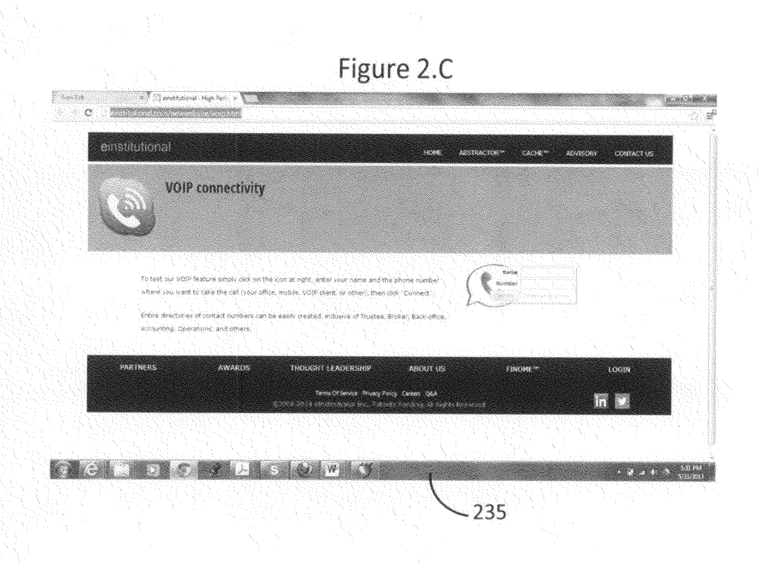

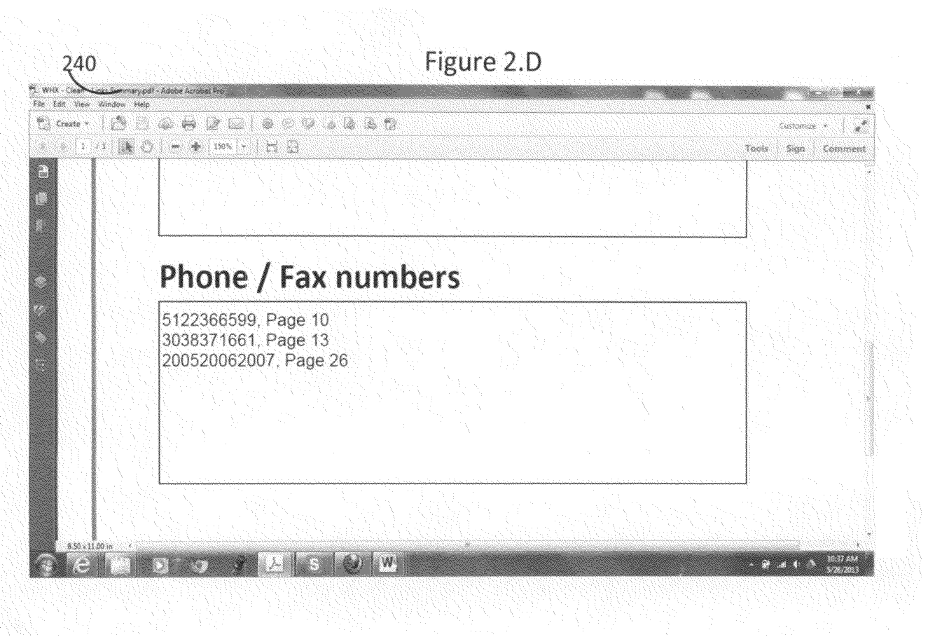

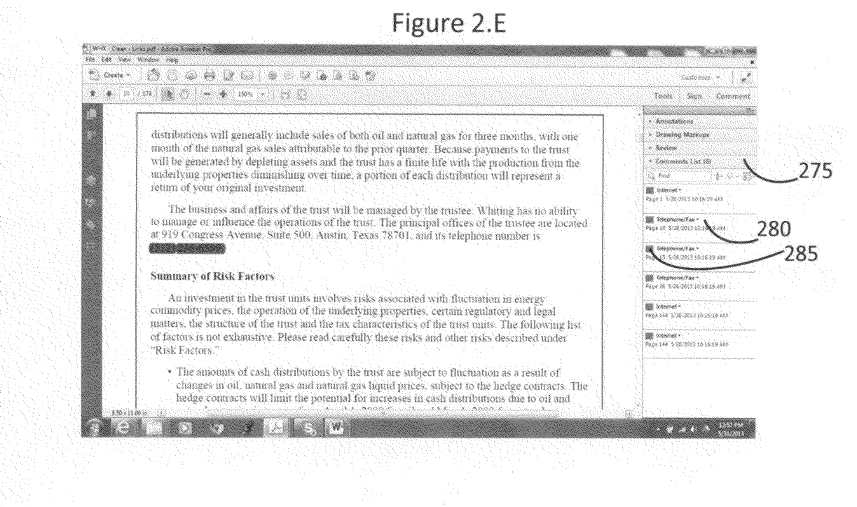

FIGS. 2A, 2B, 2C, 2D, and 2E illustrate a specific example of applying an annotation to an electronic document, with the annotation relating to defining, marking up, and recording telephone and facsimile numbers within an electronic document, and having a separate summary file of recorded numbers be created and embedded within the annotated document version. For this telephone/facsimile annotation 200, the user begins by opening an electronic document 205 within an electronic document application. The user then activates the telephone/facsimile annotation process as from a drop down menu 210 applicable for choosing among java script or any other coded processes supported by the electronic document. For this illustration, the telephone/facsimile annotation process is initiated with “Create Links (Pre-Action)” 215. When the user selects the telephone/facsimile annotation process 215, they are prompted to enter a Uniform (or universal) resource locator, or URL, for any telephone numbers 220 that are identified. The purpose for this step is to allow the user to specify a preferred Voice over internet provider, or VOIP, so that in the event the telephone/facsimile annotation process defines, marks up, and records one or more telephone numbers within an electronic document, the user can click on the annotated telephone number 225 within the electronic document created with the telephone/facsimile annotation process 230 and be automatically provided with an opened VOIP web page 235. The opened web page 235 provides the means for the user to initiate a telephone connection with the party associated with the corresponding annotated telephone number 225. Another user prompt associated with the telephone/facsimile annotation process can ask the user to specify a preferred summary template for purposes of recording any identified telephone or facsimile numbers and the page number of the original electronic document 205 and annotated electronic document 230 where those numbers appear. The pagination of the annotated electronic document is identical to the pagination of the original electronic document. The populated template 240 is automatically generated as part of the annotation tool process, may be included in the annotated electronic document 230 as an attachment 245, and saves the user time and effort with having to otherwise search perhaps hundreds of pages of an electronic document for each individual telephone and facsimile number. There is also the time-saving advantage that the telephone/facsimile annotation process is scripted to search for all manner of international conventions of how telephone and facsimile numbers can be stated, inclusive of, though not limited to, the use of symbols and alpha-numeric combinations in addition to basic number formats, and the script is additionally robust to account for future conventions that may differ from today's varying formats. If a user were to manually search an electronic document for all manner of international conventions of how telephone and facsimile numbers can be stated, the process would be time-consuming and additionally pose the risk that a particular convention was in some way unintentionally ignored.

The user can determine if one document is to be processed or if multiple documents are to be processed within a batch mode, and this is performed with reference to a drop down menu 250 accessible by clicking on “Create Links” 255. The initial reference electronic document 205 automatically appears in the default window 260, though the user can click on “Add files” 265 to add as many additional electronic documents as desired for batch processing purposes. After all desired files are selected, even if it is only the original reference document 205, the user clicks the start button and the annotation process is finished when the word “Completed” appears in the same location as the “Start” button 270. At the end of the run process the populated summary template 240 is generated, and is embedded as an attachment 245 within the newly annotated electronic document 230. In addition to the contribution of the populated summary template 240 as a guide to all telephone and facsimile numbers within an electronic document, and listing the respective pages where the telephone and facsimile numbers are located, a drop down menu 275 is also available to show which telephone and facsimile numbers have been identified along with their page location. The identifiers 280 cited within the drop down menu 275, such as “Telephone/Fax” 280, are also generated by the telephone/facsimile annotation process. The user can also click directly on an identifier 280 and be automatically taken to the particular page location within the annotated electronic document 230 where the respective telephone or facsimile number may be found. The identifiers 280 can also be color-coded whereby “Telephone/Fax” identifiers 280 are color-coded in red 285 while other identifiers, such as Email addresses, can be color-coded in blue or any other user defined color.

When the user or another viewer later opens the annotated electronic document 230, the annotations are displayed at the same locations where they were previously shown, and the populated summary template 240 is embedded at its same location 245 as well. The populated summary template 240 can be opened from its attachment location by simply clicking on it at 245.

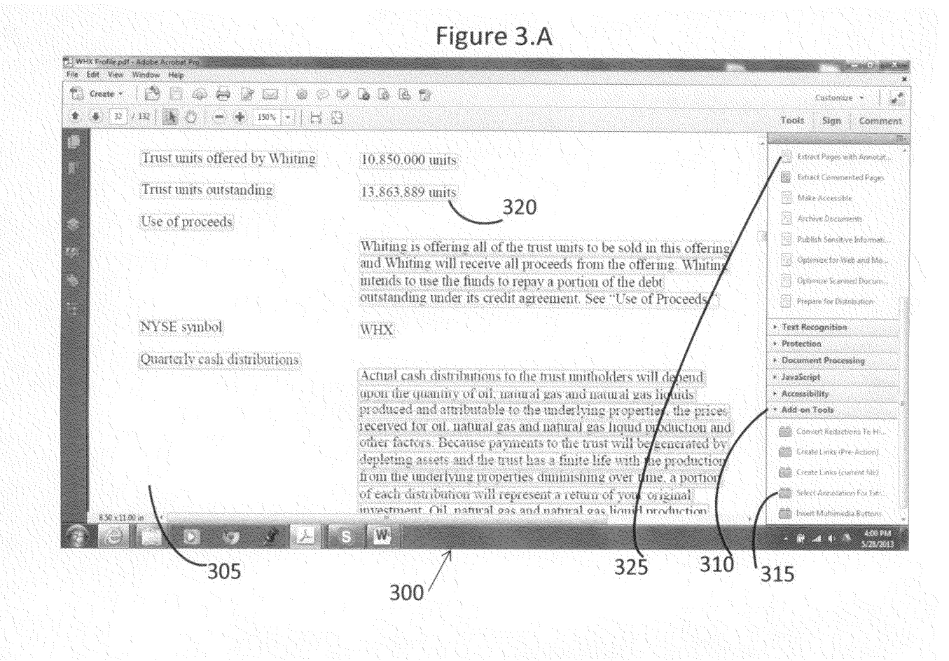

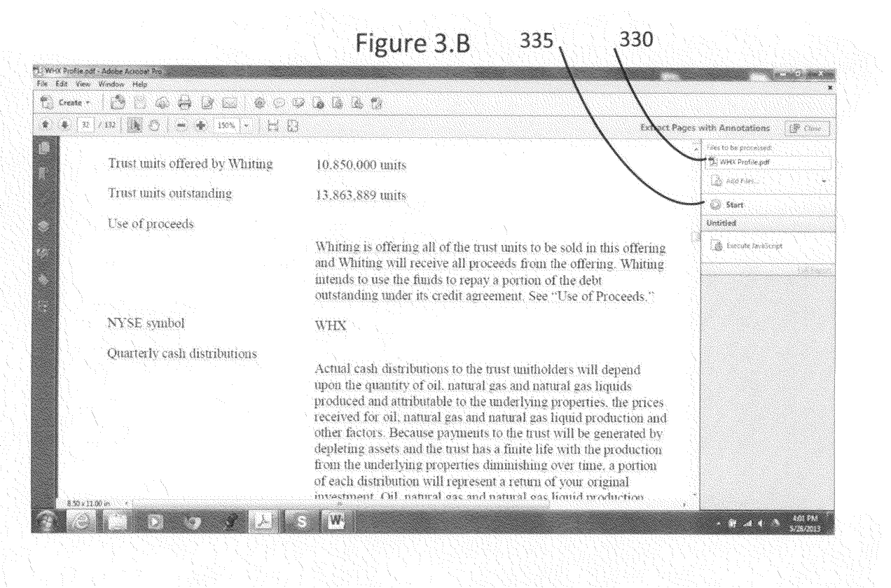

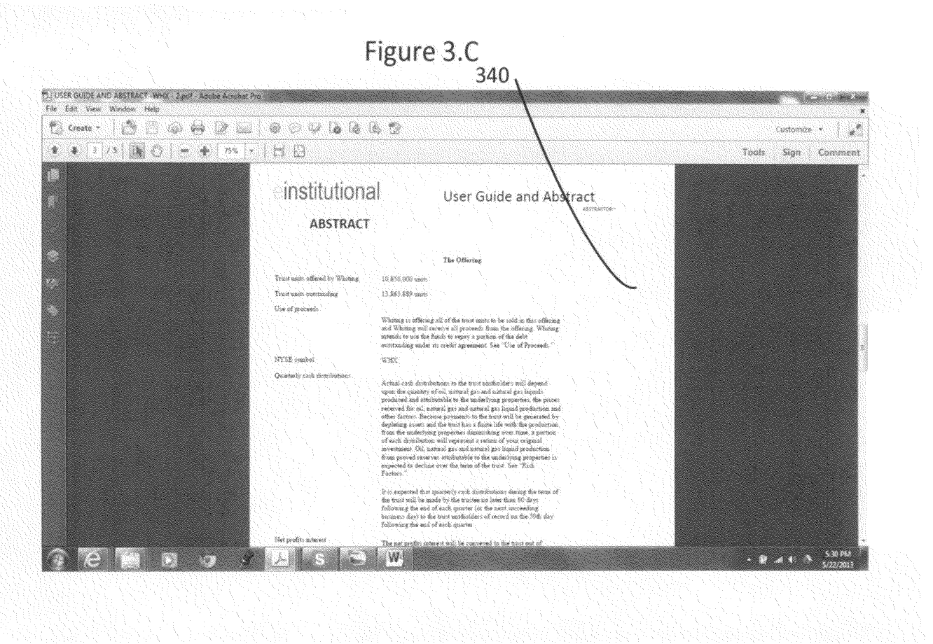

FIGS. 3A, 3B and 3C are a series of screen shots illustrating a preferred embodiment of an annotated page extraction functionality, with extracted pages saved into a single electronic document, and with the ability to have the single electronic document correspond to a user-specified format. For this extraction annotation 300, the user begins by opening an electronic document 305 within an electronic document application. The user then activates the extraction annotation process as from a drop down menu 310 applicable for choosing among java script or any other coded processes supported by the electronic document. For this illustration, the extraction annotation process is initiated with “Select annotation for extraction” 315. This step 315 allows the user to identify which particular annotation style is to be collated within the electronic document 305. For example, there may be text that is highlighted in yellow, text that is underlined in green, and many other possibilities. It is also possible that many different annotation styles are used within a single electronic document. For a user to indicate their preferred annotation style for purposes of the extraction annotation process, they simply click on any page where the annotation style is shown. For purposes of this particular demonstration, the preferred annotation style is green underlining 320, and the user need only click once on one section of green underling 320 anywhere in the electronic document 305. Even though green underlining may appear on multiple pages throughout the electronic document 305, the user is only required to identify the green underlining 320 as the preferred extraction annotation style from any one page of the electronic document 305.

After the user has identified the preferred annotation style for annotation extraction processing purposes, the user then clicks on “Extract Pages with Annotations” 325, and doing this will provide the user 325 with the opportunity to add additional electronic documents to the process in a batch mode. If multiple files are to be processed the user clicks on “Add Files”. The initial reference electronic document 305 automatically appears in the default window 330, and after all desired files are selected, even if it is only the original reference document 305, the user clicks on the “Start” button 335 and the annotation process proceeds into its final phase with the word “Completed” appearing at the “Start” button location when process has finished. At the end of the run process, every page marked with the user's preferred annotation 320 is extracted, collated, and saved into a single stand-alone electronic document 340. If desired the user can also elect to reference a preferred layout template for the collated electronic document 390, as well as have it be embedded as an attachment to the reference electronic document 305.

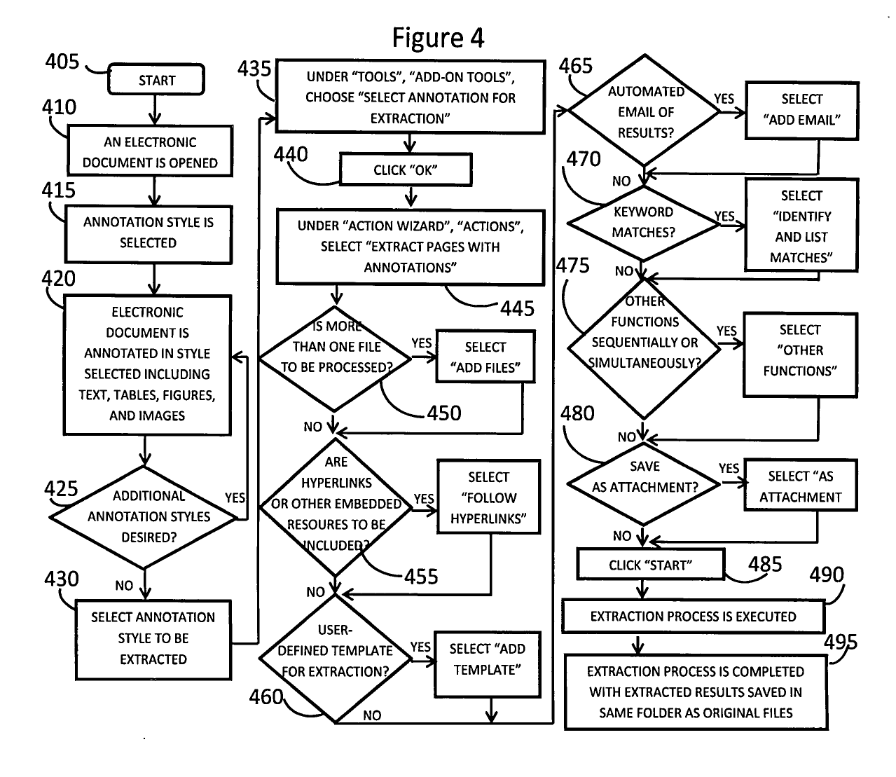

FIG. 4. Illustrates a method 100 to sequence the extraction of a particular user-defined type of annotation from an electronic document inclusive of its hyperlinks and embedded resources.

In a preferred embodiment of this annotation, the user starts (step 405) by opening the electronic document to be processed (step 410) within the context of a portable document format (PDF). Next the user selects a particular type of annotation to be applied to any text, tables, figures, or images within the electronic document (step 415) and proceeds to apply that annotation-type (step 420). For example, a user may want to use the annotation of yellow highlighting to mark items for inclusion within an extracted “Executive summary”. If additional annotations are desired (step 425), these can be added as well. For example, the user may use green underlining for text, tables, figures, or images appropriate for a “Supporting information” extraction. Next, among all the various types of annotations that a user may have applied throughout the electronic document, the then user decides which particular type of annotation will be referenced for extraction purposes (step 430). If it is desired to extract all annotations in yellow highlighting, the user simply selects any yellow highlighted portion of text, tables, figures, or images on any page of the electronic document. After selecting the particular type of annotation that is to be referenced for extraction, the user initiates the procedure to invoke the extraction function call (steps 435, 440, 145). Next the user decides if only one electronic document is to be processed for this particular extraction routine, or if a batch process is to be executed (step 450). The user also has the ability to indicate if it is desired to follow hyperlinks or other resources embedded in the electronic document for inclusion in the extraction process (step 455), or if the user would like to have extracted results presented within a user-defined extraction template (step 160). The user has the additional choice of having the extraction results presented as a stand-alone file or as a file attachment within the original reference document (step 465), as well as the option of having extraction results automatically emailed to user-specified recipients (step 470). If it is desired that a user-defined list of keywords be compared with extracted content to identify and list matches, the user can select this feature as well (step 475). The option of having automatically-tagged keywords included in the extraction template is a time-saving benefit that saves the user from having to manually identify keywords after the extraction process is completed, and additionally helps to reduce errors and omissions that can arise from manual-intensive procedures. An additional benefit of the keyword extraction process is that those keywords can be synchronized with real-time events. In one embodiment, streaming real-time data, as with Really Simple Syndication (or RSS), could be coupled with a keyword matching process whereby a flag is automatically generated whenever a keyword appears in both the real-time feed and any document of interest. Although an RSS feed is typically a text-based data stream, a variety of multi-media formats can be accommodated for keyword searches inclusive of audio and video files. Another example of the streaming media functionality would be in the context of a medical doctor and patient records. An RSS linked to articles of leading medical journals could be fed across multiple patient files in search of keywords pertaining to symptoms or, maladies, and when keyword matches occurred these could be flagged for further review.

There may also be situations where it is desirable to discern if keywords are within an electronic document, and if so, to mark up those on the pages where they exist within the electronic document as well as within any hyperlinks or embedded resources. For example an insurance underwriter may want to see which policies within her portfolio that contain a particular type of coverage, and may additionally want to mark the specific instances where those references appear on each page of the respective policies inclusive of hyperlinks or embedded cross-referencing multi-media such as special riders or policy exemptions. To achieve this, the underwriter would simply invoke the relevant annotation function call. When the annotation process was completed, the resulting electronic document file markup may include an easily accessible drop down list where each insurance policy reference could be separately clicked to take a user directly to the page where the reference appeared. This functionality can be especially useful when there are multiple keywords of interest, since the process described here can accommodate an unlimited number of keyword searches and annotations within a single run.

Next the user indicates if there are any other functions that they would like to have run sequentially or simultaneously with the extraction process (step 480). For example, concurrent with running the extraction process, the user can choose to have multi-media inserted into the extraction template at user-specified locations. The user next clicks the “Start” button (step 485), the extraction process is executed (step 490), and the extraction process is completed with extracted results saved within the same folder where the original document files are located (step 495).

FIG. 5 illustrates a method 500 to sequence the embedding of one or more media files of varying types into designated locations of an electronic document, and with a registry of media types and respective page locations also available within a drop down menu embedded within the same electronic document. While there is existing annotation software does allow for multi-media to be inserted into electronic documents, there are no advanced automated processes that will place a variety of multi-media in specific document locations specified by a user for either a single document or as a batch processing routine.

In a preferred embodiment of this embedded media annotation, the method begins with the user identifying the electronic documents to be processed (step 510). Electronic documents can be processed individually or with an automated batch process. A user then inserts the embedded media annotation function call into the electronic document annotation process (step 520), and executes instructions inclusive of providing an electronic file list that contains pairings between keywords and associated media files of interest to the user (step 530). For example, the user may be in the medical profession and interested in adding educational media to journal articles published in electronic documents. Accordingly, the user may want to pair the keyword “amnesia” with a video entitled “symptoms of amnesia”, and the keyword “insomnia” with a podcast entitled “cures for insomnia.” The electronic file list can be of any file-type capable of being read or used as an input file, and keywords can consist of single words or multiple words and any combination of numbers, letters, alphanumerics, symbols, or any other expressions.

Next the user executes the annotation function call (step 540), and in so doing the embedded media annotation process is run. The annotation process consists of identifying any keyword matches between the electronic file list (step 530) and electronic documents identified by the user (step 510), and in the event that a match is identified, pairing the keyword with its respective media file. For example, if the word “amnesia” is found within any of the electronic documents identified by the user (step 510), then the appropriate electronic document is opened and the “symptoms of amnesia” video is embedded within the electronic document at the same line of the page where the word “amnesia” appears. If other keyword/media file pairs are also identified, then those are processed as well. At the completion of the pairing process a registry of keyword/media file pairs and their respective page locations is available as a drop down menu embedded within the annotated electronic document (step 550). When the drop down menu is accessed by the user, and when the user clicks on a particular keyword/media file pairing within the drop down menu, the user is taken to the particular page where the keyword/media file is referenced.

When the user or another viewer later opens the annotated electronic document, the annotations are displayed at the same locations where they were previously shown, and the embedded media files will be in their same location as well.

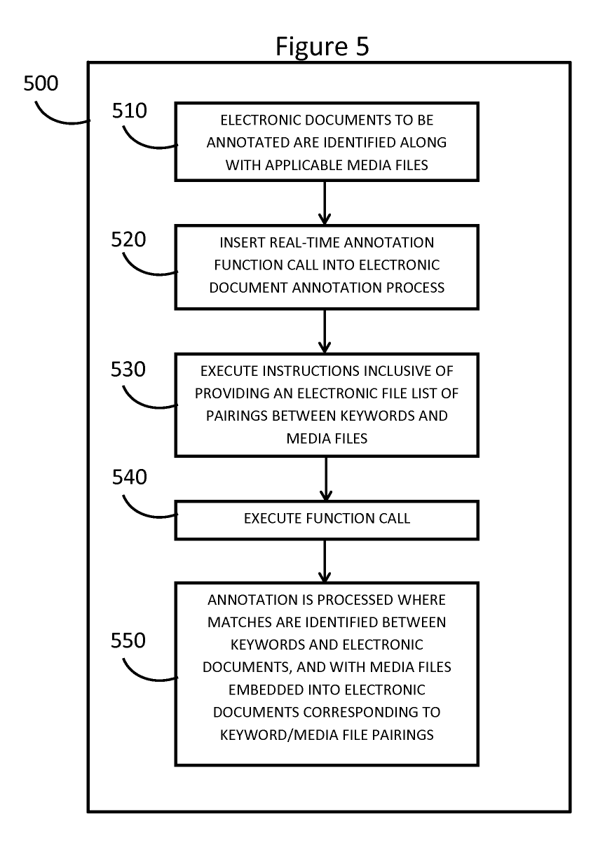

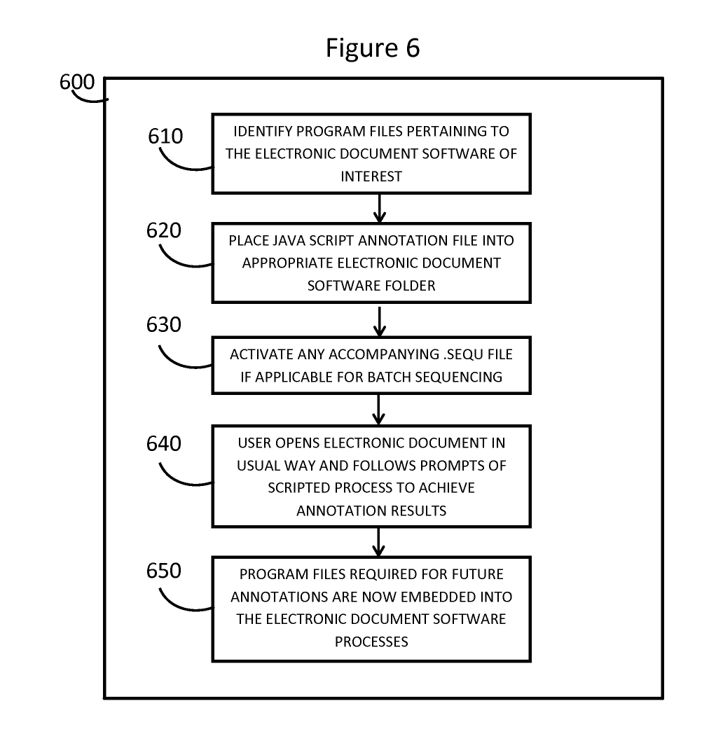

FIG. 6 illustrates a method 600 to sequence incorporating an annotation function call within the annotation process of an electronic document in the instance of a java script routine. In a preferred embodiment the method begins with the user identifying the program files pertaining to the electronic document software of interest (step 610). Electronic document software may include, though is not limited to, Microsoft office, Google Docs, iWork, and Adobe products. With this preferred embodiment the user places the java script annotation file into the appropriate electronic document software folder (step 620), and any accompanying file relevant for batch sequencing (as with a .SEQU file) is activated (step 630). The user then references the applicable electronic document software to open an electronic document in the usual way, and follows the prompts of the scripted process to achieve the desired annotation results for that electronic document (step 640). The program files required for any future annotations are now embedded into the electronic software processes (step 650).

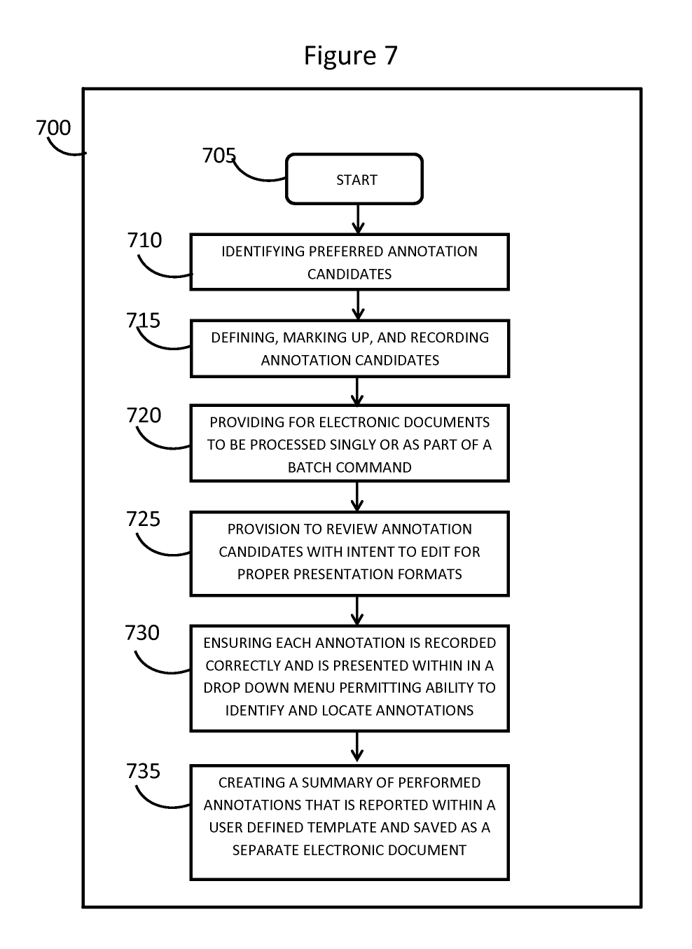

FIG. 7 illustrates one embodiment of a method 700 for programming an electronic document annotation function call with batch processing capabilities. It will be appreciated by those skilled in the art that other code configurations may be used in place of the following examples. Beneficially, java script scripting may be enabled for different electronic document software platforms without major application or code changes. Furthermore, the method of implementing these changes is highly flexible.

One such method 700 starts 705 with identifying 710 preferred annotation candidates inclusive of, though not limited to, telephone and facsimile numbers, Email addresses, and URLs. This then leads 715 to a detailing of respective, annotation functions inclusive of, though not limited to, defining, marking up, and recording of all manner of international telephone codes, potential Email address extensions, URL formats, and related exigencies. Existing annotation software does not adequately address the dynamic nature of URLs and the fact that new extensions (.com, .net, and many others) are constantly being added. The present disclosure accommodates this reality, and as such, ensures that users who invoke an automated search and annotation of URLs will receive a complete profile. Existing annotation software is also weak with respect to the proper identification of Email addresses. This is partly due to the constant addition of new extensions, and partly attributable to confusion over how to meaningfully distinguish between a web address and an Email address. The present disclosure accommodates this as well. It is additionally permitted 720 to have an electronic document processed singly, or with multiple electronic files as part of a batch process. To assist with having annotations marked as cleanly as possible, without extraneous characters, punctuation, or other markings, provision 725 is made to review annotation candidates with the intent of editing them for proper presentation. There is also the matter 730 of having each annotation recorded in the correct way (as a telephone or facsimile number, as an Email address, or as a web address) and made available in a drop down menu to permit a user to easily identify and locate particular annotations within an electronic document. Finally there is the matter of creating 735 a separate electronic document summarizing the performed annotations, having that summary be reported within a particular user defined template, and with the summary saved as a separate electronic document.

The following java script sample presents coding commensurate with the aforementioned functionality.

TABLE 0001
Identification of keywords
if (app.viewerVersion < 10) {app.addMenuItem({ cName: “FindPatternsUserInput”, cUser:
“Create Links (Pre-Action)”, cParent: “Tools”, cExec: “findPatternsUserInput( );”, cEnable:
“event.rc = true;”}); app.addMenuItem({ cName: “FindPatterns”, cUser: “Create Links (current
file)”, cParent: “Tools”,cExec: “findPatternsUserInput( ); findPatterns(false);”, cEnable: “event.rc
= (event.target != null);”});} else { app.addToolButton({ cName: “FindPatternsUserInput”,
cLabel: “Create Links (Pre-Action)”, cExec: “findPatternsUserInput( );”, cEnable: “event.rc =
true;”}); app.addToolButton({ cName: “FindPatterns”, cLabel: “Create Links (current file)”,
cExec: “findPatternsUserInput( ); findPatterns(false);”, cEnable: “event.rc = (event.target !=
null);”}); } function findPatternsUserInput( ) { if (global.phoneUrl!=null) delete global.phoneUrl;
if (global.summaryFilePath!=null) delete global.summaryFilePath; var resp =
app.response(“Enter the URL to be used for Phone Numbers (use _NUM_{—} where you want the
number to be inserted):”,“”,“http://www.slype.com/en/download-skype/click-to-call/”); if
(resp==null) return; global.phoneUrl = resp;app.alert(“Select the template file...”,3); var
newDoc= myTrustedNewDoc( );var f = newDoc.addField(“FileInput”, “text”,0, [0,0,1,1]);
myTrustedFieldFileSelect(f,true); f.browseForFileToSubmit( ); if (f.value!=null && f.value!=“”) {
global.summaryFilePath = convertRealPathToPDFPath(f.value); } newDoc.closeDoc(true); }
function findPatterns(isBatch) { if (global.phoneUrl==null) { app.alert(“Error! You must enter
the URL to be used for phone numbers.”); if (isBatch) { event.rc = false; } return; } if
(global.summaryFilePath==null) { app.alert(“Error! You must select the template file.”); if
(isBatch) { event.rc = false; } return; } var internetDomains =
[“arpa”,“com”,“edu”,“firm”,“gov”,“int”,“mil”,“mobi”,“nato”,“net”,“nom”,“org”,“store”,“web”]; var
br = “\r\n”; var urls = [ ]; var emails = [ ]; var phoneNums = [ ]; var telephonePattern1 =
/\hat{ }\d{10}$/; var telephonePattern2_1 = /\hat{ }\(\d{3}\)/; var telephonePattern2_2 = /\hat{ }\d{3}-?/;
var telephonePattern2_3 = /\hat{ }\d{4}/; for (var p=0; p<this.numPages; p++) { var numWords =
this.getPageNumWords(p); var phoneNumCandidate = “”; var urlQuads = [ ]; var emailQuads =
[ ]; var phoneQuads = [ ]; for (var i=0; i<numWords; i++) { var word =
Mark-up process
this.getPageNthWord(p,i,false); if (word==“http://” || word==“www.”) { var wordQuads =
this.getPageNthWordQuads(p,i); for (var q in wordQuads) urlQuads.push(wordQuads[q]); var
nextWord = word; var url = “”; i++; while (i<numWords) { url += nextWord; if
(/\hat{ }htm/.test(nextWord) || /[\/\._-]$/.test(nextWord)==false) { break; } var wordQuads =
this.getPageNthWordQuads(p,i); for (var q in wordQuads) urlQuads.push(wordQuads[q]);
nextWord = this.getPageNthWord(p,i,false).replace(/[\r\n]+$/,“”); i++; } url = trim(url); var
found = false; for (var m in urls) { if (urls[m].text==url) { found = true; break; } } if (!found)
urls.push({text: url, page: p, quads: urlQuads, type: “url”}); urlQuads = [ ]; } if
(internetDomains.indexOf(trim(word))!=−1 && /\.$/.test(trim(this.getPageNthWord(p,i−
1,false)))) { var originalI = i; var wordQuads = this.getPageNthWordQuads(p,i); for (var q in
wordQuads) urlQuads.push(wordQuads[q]); var nextWord = word; var url = “”; i++; while
(i<numWords) { url += nextWord; if (/\hat{ }htm/.test(nextWord) || /[\/\._-
]$/.test(nextWord)==false) { break; } var wordQuads = this.getPageNthWordQuads(p,i); for
(var q in wordQuads) urlQuads.push(wordQuads[q]); nextWord =
this.getPageNthWord(p,i,false).replace(/[\r\n]+$/,“”); i++; } var j=originalI−1; while (j>=0) {
var prevWord = this.getPageNthWord(p,j,false); console.println(“prevWord:”+prevWord); if
(/\.$/.test(prevWord)==false) break; url = prevWord + url; var wordQuads =
this.getPageNthWordQuads(p,j); for (var q in wordQuads) urlQuads.unshift(wordQuads[q]); j−−;
} url = trim(url); var found = false; for (var m in urls) { if (urls[m].text==url) { found = true;
break; } } if (!found) urls.push({text: url, page: p, quads: urlQuads, type: “url”}); urlQuads =
[ ]; } if (/@/.test(word)) {var originalI = i; var email = word; var wordQuads =
this.getPageNthWordQuads(p,i); for (var q in wordQuads) emailQuads.push(wordQuads[q]); for
(var j=i+1; j<numWords; j++) { var nextWord = this.getPageNthWord(p,j,false); email +=
nextWord; var wordQuads = this.getPageNthWordQuads(p,j); for (var q in wordQuads)
emailQuads.push(wordQuads[q]); if (/\.$/.test(nextWord)==false) { break; } } i=j; for (var
k=originalI−1; k>=0; k−−) { var prevWord = this.getPageNthWord(p,k,false); if
(/\.$/.test(prevWord)==false) { break; } email = prevWord + email; var wordQuads =
this.getPageNthWordQuads(p,k); for (var q in wordQuads) emailQuads.unshift(wordQuads[q]);
} email = trim(email); if (/\hat{ }.+@.+\..+$/.test(email)) { var found = false; for (var m in emails)
{ if (emails[m].text==email) { found = true; break; } } if (!found) emails.push({text: email,
page: p, quads: emailQuads, type: “email”}); } emailQuads = [ ]; } if (/[\/,%]/.test(word)) {
phoneNumCandidate = “”;phoneQuads = [ ]; } else { var cleanWord =
word.replace(/\hat{ }\W+/,“”); cleanWord = cleanWord.replace(/\W+$/,“”); if
(/\hat{ }\d*$/.test(cleanWord)) { phoneNumCandidate+=cleanWord; var wordQuads =
this.getPageNthWordQuads(p,i); for (var q in wordQuads) phoneQuads.push(wordQuads[q]); }
else { if (phoneNumCandidate.length>=10 && phoneNumCandidate.length<=12) {
phoneNumCandidate = trim(phoneNumCandidate); var found = false; for (var m in
phoneNums) { if (phoneNums[m].text==phoneNumCandidate) { found = true; break; } } if
(!found) phoneNums.push({text: phoneNumCandidate, page: p, quads: phoneQuads, type:
“phone”}); } phoneNumCandidate = “”; phoneQuads = [ ]; } } } } for (var i=0; i<urls.length;
i++) { urls[i].text = removeSurrondingPunctuation(urls[i].text); addHighlightAndLink(this,
urls[i].page, urls[i].quads, urls[i].type, urls[i].text); } for (var i=0; i<emails.length; i++) {
emails[i].text = removeSurrondingPunctuation(emails[i].text); addHighlightAndLink(this,
emails[i].page, emails[i].quads, emails[i].type, emails[i].text); } for (var i=0;
i<phoneNums.length; i++) { addHighlightAndLink(this, phoneNums[i].page,
phoneNums[i].quads, phoneNums[i].type, phoneNums[i].text); } var originalDoc = this; var
Preparation of separate summary document
summaryDoc = app.openDoc(global.summaryFilePath); var urlsString = “”; if (urls.length==0)
{ urlsString = “ -- NONE FOUND -- ”; } else { for (var i=0; i<urls.length; i++) { urlsString +=
urls[i].text + “, Page ” + (urls[i].page+1) + br; } } summaryDoc.getField(“URLS”).value =
urlsString; var emailsString = “”; if (emails.length==0) { emailsString = “ -- NONE FOUND -- ”;
} else { for (var i=0; i<emails.length; i++) { emailsString += emails[i].text + “, Page ” +
(emails[i].page+1) + br; } } summaryDoc.getField(“EMAILS”).value = emailsString; var
phonesString = “”; if (phoneNums.length==0) { phonesString = “ -- NONE FOUND -- ”; } else {
for (var i=0; i<phoneNums.length; i++) { phonesString += phoneNums[i].text + “, Page ” +
(phoneNums[i].page+1) + br; } } summaryDoc.getField(“PHONES”).value = phonesString; var
tempPath = myTrustedGetPath(“user”,“temp”) + “/”; var summaryPath = tempPath +
originalDoc.documentFileName.replace(/\.pdf$/i, “ - Links Summary.pdf”);
myTrustedSaveAs(summaryDoc, summaryPath); summaryDoc.closeDoc(true);
myTrustedImportDataObject2(originalDoc, “Links”, summaryPath);
myTrustedSaveAs(originalDoc, originalDoc.path.replace(/\.pdf$/i, “ - Links.pdf”)); if (!isBatch) {
app.alert(“Done.”,3); } } function addHighlightAndLink(doc, p, q, type, param) { if
(type==“url”) { myAuthor = “Internet”; mySubject = “Webpage”; } else if (type==“email”) {
myAuthor = “Email”; mySubject = “Email address”; } else if (type==“phone”) { myAuthor =
“Telephone/Fax”; mySubject = “Telephone or Fax number”; } doc.addAnnot({ type: “Highlight”,
page: p, quads: q, author: myAuthor, subject: mySubject, strokeColor: color.red }); var I =
doc.addLink(p, convertMultipleQuadsToRect(doc, p, q)), if (type==“url”) {
I.setAction(“app.launchURL(\“”+param+“\”)”); } else if (type==“email”) {
I.setAction(“app.launchURL(\“mailto:”+param+“\”)”); } else if (type==“phone”) {
I.setAction(“app.launchURL(\“”+ global.phoneUrl.replace(“_NUM_”,param) + “\”)”); } } function
convertMultipleQuadsToRect(doc, p, q) { var m = (new Matrix2D).fromRotated(doc,p); var
mInv = m.invert( ) var r1 = mInv.transform(q[0]) r1 = r1.toString( ) r1 = r1.split(“,”); var rect1
= [+r1[4], +r1[5], +r1[2], +r1[3]]; var i = q.length−1; var rect2 = [ ]; do { var r2 =
mInv.transform(q[i]) r2 = r2.toString( ) r2 = r2.split(“,”); rect2 = [+r2[4], +r2[5], +r2[2],
+r2[3]]; i−−; } while (i>0 && rect2[1].toFixed(0)!=rect1[1].toFixed(0)); var rect = [+rect1[0],
+rect1[1], +rect2[2], +rect2[3]]; return red; } function removeSurrondingPunctuation(s) { s =
s.replace(/[\.\)\[\];]+$/,“”); s = s.replace(/\hat{ }[\(\[\]]+/,“”); return s; } function trim(s) { if
(typeof s != “string”) return s; return s.replace(/\hat{ }\s+/,“”).replace(/\s+$/,“”); } function
convertRealPathToPDFPath(str) { if (app.platform==“WIN”) { if (str.charAt(0)==“\\”) // no
drive return str.replace(/\hat{ }\\/, “//”).replace(/\\/g, “/”); else return “/” +
str.replace(“:\\”,“/”).replace(/\\/g, “/”); } if (app.platform==“MAC”) { return “/” +
str.replace(/:/g, “/”); } return str; } safeSaveAs =
app.trustPropagatorFunction(function(doc,vPath){ app.beginPriv( ); doc.saveAs({cPath:vPath});
app.endPriv( ); }); myTrustedSaveAs = app.trustedFunction(function(doc,vPath){
app.beginPriv( ); safeSaveAs(doc,vPath); app.endPriv( ); }); myNewDoc =
app.trustPropagatorFunction(function( ){ app.beginPriv( ); return app.newDoc( ); app.endPriv( );
}) myTrustedNewDoc = app.trustedFunction(function( ) { app.beginPriv( ); return myNewDoc( );
app.endPriv( ); }); myBrowseForFolder = app.trustPropagatorFunction(function( ){
app.beginPriv( ); return Collab.browseForFolder( ); app.endPriv( ); }) myTrustedBrowseForFolder
= app.trustedFunction(function( ) { app.beginPriv( ); return myBrowseForFolder( );
app.endPriv( ); }); myFieldFileSelect = app.trustPropagatorFunction(function(f, value){
app.beginPriv( ); f.fileSelect = value; app.endPriv( ); }) myTrustedFieldFileSelect =
app.trustedFunction(function(f, value) { app.beginPriv( ); myFieldFileSelect(f, value);
app.endPriv( ); }); myImportDataObject2 =
app.trustPropagatorFunction(function(doc,vName,vPath){ app.beginPriv( );
doc.importDataObject({cName: vName, cDIPath: vPath}); app.endPriv( ); });
myTrustedImportDataObject2 = app.trustedFunction(function(doc,vName,vPath) {
app.beginPriv( ); myImportDataObject2(doc,vName,vPath); app.endPriv( ); }); myGetPath =
app.trustPropagatorFunction(function(v1,v2){ app.beginPriv( ); return app.getPath(v1,v2);
app.endPriv( ); }); myTrustedGetPath = app.trustedFunction(function(v1,v2) { app.beginPriv( );
return myGetPath(v1,v2); app.endPriv( ); });

With the java script presented above, the user can process one or more annotations sequentially or simultaneously, for a single electronic document or batch of documents, with a summary of results generated as a separate report presented within a user defined template, all within a single call function process.

With respect to the processing of annotation functionality, existing annotation software is typically limited to running one particular type of annotation at a time. The present disclosure permits more than one annotation process to be run, and with the user's choice of being run simultaneously or sequentially.

What is claimed is:

1. A non-transitory computer-readable medium storing instructions that when executed by a computing device direct the processor to perform a method, the method comprising: the accessing of annotation function calls in relation to electronic documents, wherein annotation function calls may include information for defining, marking up, recording, importing, exporting, and extracting data elements, and the following hyperlinks for any additional annotations that may be performed; invoking single or multiple annotation function calls, capable of integration with a variety of electronic document software platforms, with annotation results stored within an electronic document; processing annotation function calls one electronic document at a time or in a batch, where annotation function calls can be processed individually or in combination with other annotation function calls, and multiple annotation function calls can be processed sequentially or simultaneously; providing a summary file that profiles annotation function call results, and is generated as an attachment to a final resulting annotation markup file or as a separate electronic document.

2. The method of claim 1, wherein the annotation function call consists of automatically annotating, defining, and recording all manner of telephone numbers in an electronic document.

3. The method of claim 1, wherein another type of annotation function call consists of automatically annotating, defining, and recording all manner of facsimile numbers in an electronic document.

4. The method of claim 1, further comprising a type of annotated functionality consisting of automatically annotating, defining, and recording all manner of Uniform (or universal) resource locators (or URLs) in an electronic document.

5. The method of claim 1, further comprising a type of annotated functionality consisting of automatically annotating, defining, and recording all manner of electronic mail (or Email) addresses in an electronic document.

6. The method of claim 1, further comprising a type of annotation function call consisting of automatically annotating, defining, and recording user-defined keywords in an electronic document.

7. The method of claim 1, further comprising functionality whereby pages in electronic documents that are annotated in part or in whole may be wholly extracted according to a user-selected type of annotation.

8. The method of claim 7, further comprising the ability to have extracted annotations collated and saved into a separate electronic document template of a user-defined layout and format.

9. The method of claim 7, additionally comprising the ability to follow any hyperlinks contained within electronic documents, and if those hyperlinks reference any other electronic documents having annotations according to a user-selected type, then those hyperlinked pages are wholly extracted.

10. The method of claim 1, further comprising the ability to annotate, define, and record keyword matches between real-time data streams and corresponding keywords within electronic documents.

11. The method of claim 10, further comprising the ability to automate the following of hyperlinks and embedded multi-media within the original document in search of keyword matches.

12. The method of claim 10, additionally comprising an automated alert feature whereby a user may be notified whenever an electronic document keyword is matched with a real-time data stream.

13. The method of claim 10, wherein a real-time data stream may consist of text, audio, video, or other media.

14. The method of claim 1, further comprising the ability to process electronic documents on an individual file basis.

15. The method of claim 1, further comprising the ability to process electronic documents on a multiple file basis using batch processing.

16. The method of claim 1, further comprising the ability to generate a final resulting annotation markup file as an electronic document.

17. The method of claim 1, further comprising the ability to include a summary annotation profile that is generated as a separate electronic document attachment embedded as an attachment within a final resulting annotation markup file.

18. The method of claim 17, further comprising the ability to present the summary annotation profile as a separate electronic document not embedded as an attachment within a final resulting annotation markup.

19. The method of claim 1, further comprising the ability to import multimedia into specific user-selected locations within an electronic document.

20. The method of claim 19, whereby multimedia refers to text, audio, video, or other media.

21. The method of claim 1, further comprising the functionality whereby every any portable file document created can be saved conforming to industry standards including ISO 32000 and PDF/X formats.

22. The method of claim 1, further comprising the functionality whereby each annotation function call can be run individually or in combination with any other function.

23. The method of claim 1, further comprising the functionality whereby multiple annotation function calls can be run simultaneously or sequentially.

24. The method of claim 1, further comprising the ability to process electronic documents created using any machine readable language.
